(19) United States
(12) Patent Application Publication
(10) Pub. No.: US 2024/0101907 A1
(43) Pub. Date: Mar. 28, 2024

(54) PROCESS FOR A PLASTIC PRODUCT CONVERSION

(71) Applicant: Michiel CRAMWINCKEL, Voorburg (NL)

(72) Inventor: Michiel CRAMWINCKEL, Voorburg (NL)

(21) Appl. No.: 17/768,992

(22) PCT Filed: Oct. 29, 2020
(86) PCT No.: PCT/EP2020/080413

§ 371 Date: Apr. 14, 2022

(30) Foreign Application Priority Data
Oct. 29, 2019 (NL) 2024115
Sep. 11, 2020 (WO) PCT/EP2020/075469
Sep. 23, 2020 (NL) 2026522

(51) Int. Cl. C10B 53/07; C10B 47/04

(52) U.S. Cl. CPC C10B 53/07; C10B 47/04

(57) ABSTRACT

The invention is directed to a process for a combined biomass and plastic product conversion by subjecting a moulded product comprising of between 1 and 20 wt % of a plastic product and between 99 and 80 wt % of a torrefied biomass to a pyrolysis or mild gasification thereby obtaining a gaseous fraction comprising hydrogen, carbon monoxide and a mixture of gaseous organic compounds and a char product.

The invention is directed to a process for a plastic product conversion process.

Plastic products conversion processes are mainly found in the field of recycling of waste polymer products, also referred to as waste plastics. In such processes a set of operations is performed on waste composed of plastic materials in order to obtain new material to be reintroduced in production processes. After the sorted waste collection step, the plastic is taken to first selection and treatment plants; it is then separated from other fractions and impurities and then divided by polymer type. In particular, low- and high-density PET and PE are selected. Various methods for mechanical recycling are known which are adapted to obtain flakes or granules which are then used to produce new objects.

US2007187299 describes a process wherein waste polymers are isolated from other waste by a selection based on the dielectric constant of the material. This separation separates polymer materials having a dielectric constant below a certain threshold, such as polypropylene and polyethylene, polystyrene and ABS from materials having a higher dielectric such as wet or moist wood, foam and rubber.

US2004226864 describes a process to separate polymer films from garbage by flotation. The publication states that this avoids plastic film products such as plastic bags to end up in a landfill. The publication is however silent how the plastic film is to be further used.

Because plastics cannot be recycled indefinitely and only 50% of the total of plastic waste can be reused validly in a production process the remaining 50% is not suitable for various reasons. These reasons may be for example the excessive degree of contamination of plastics, the loss of technical properties due to past recycling/reuse cycles, the impossibility to perform a selection of the various types of plastic for finer fractions. This remaining 50% of plastic waste is currently disposed by waste-to-energy conversion or by landfill disposal.

Waste-to-energy conversion uses waste treatment plants (waste-to-energy plants) which allow to recover the heat generated during the combustion of said waste and use it to generate steam, which is then used to generate electric power or as a heat transfer medium, for example for remote heating. Although modern waste-to-energy conversion plants have many advantages with respect to simple incinerators, waste-to-energy conversion processes remain characterized by negative economic and environmental impacts; in general, they are unable to reach an economic balance only through the generation and sale of thermal and/or electric power. From the environmental standpoint, waste-to-energy conversion processes are characterized by all the negative impacts linked to waste combustion processes, such as, by way of nonlimiting example, carbon dioxide emissions in the atmosphere, production of dangerous and non-dangerous waste and production of wastewater.

So-called “Plastic-To-Fuel” (PTF) technologies are known which consist of processes aimed at converting waste and plastic materials into liquid fuels or synthetic oils, mainly based on the two processes of simple pyrolysis and catalytic pyrolysis. WO2019003253 describes a PFT process which cracks a mixture of molten plastics in the presence of a liquid catalyst at a temperature between 350 and 500° C. to non-condensable gasses, such as methane and carbon monoxide and liquid hydrocarbon fuel fractions. A disadvantage of this process is that it makes use of a catalyst. The catalyst will have to be recovered from the liquid products making the process complex. A general disadvantage of PTF processes is that the quality of the fuel is such that they are not directly useable as transportation fuels like gasoline or diesel.

WO2018/224482 describes a process to recycle polystyrene containing plastic waste mixture by pyrolysis to obtain styrene. A disadvantage is that although styrene yields are high also significant amounts of by-products are formed.

US2019/0218371 describes a composite of recycled polypropylene and torrefied surghum and recycled polypropylene and torrefied walnut shells. The content of the torrefied biomass ranged from 5 to 30 wt % in the composite. The torrefied biomass was added to the plastic composite to improve the mechanical properties of the recycled plastic.

WO2019/054868A8 described a process where pellets of torrefied biomass are subjected to a to a pyrolysis or mild gasification thereby obtaining a gaseous fraction comprising hydrogen, carbon monoxide and a mixture of gaseous organic compounds and char particles.

The aim of the present invention is to provide a simple process that is capable of conversion of a plastic product to useful products not having some of the above described disadvantages. This object is achieved by the following process.

This aim is achieved with the following process. Process for a combined biomass and plastic product conversion by subjecting a moulded product comprising of between 1 and 20 wt % of a plastic product and between 99 and 80 wt % of a torrefied biomass to a pyrolysis or mild gasification thereby obtaining a gaseous fraction comprising hydrogen, carbon monoxide and a mixture of gaseous organic compounds and a char product.

Applicants found that when moulded products of a solid torrefied biomass and plastic product are subjected to a pyrolysis or mild gasification a char product is obtained having a low volatiles content and a high active surface expressed as BET (N2) active surface. This makes the char product, also referred to as char particles, a valuable product of this process. Further a high yield of the gaseous reaction products such as hydrogen and carbon monoxide is obtained. This method of pyrolysis or mild gasification of torrefied biomass is further advantageous because it avoids that the ash forming compounds as present in the biomass forms a slag. The char particles as obtained will comprise these ash forming compounds and carbon. The gaseous fraction comprising hydrogen, carbon monoxide and a mixture of gaseous organic compounds is suitably further processed in a downstream high temperature partial oxidation. Such a higher temperature favours the conversion of the hydrocarbons such as the gaseous tar compounds, which may be present in the gaseous reaction products, to hydrogen and carbon monoxide. Because the ash forming compounds remains within the char product formation of molten slag is thus avoided in such a next partial oxidation process.

It is found that the plastic product as present in a moulded product will more easily pyrolyze or gasify to the valuable gaseous compounds like hydrogen and carbon monoxide. The plastic product will less likely form a large volume of a melted plastic because of the plastic is diluted within the torrefied biomass. This also results in that no oil product is formed. Part of the plastic product and the torrefied biomass will carbonize to coke thereby obtaining a char product. This coking tendency will be more apparent for aromatic polymers such as polystyrene and less apparent for polyolefins. A further advantage of this coke make is that part of the carbon of the plastic product is fixed as coke in the char product and not converted to carbon dioxide as would be the situation in a waste to energy conversion process.

The combination with a plastic product makes the moulded products less sensitive for attrition and results in a moulded product having a higher impact resistance. This will lower the dust formation when handling and during storage of such moulded products as compared to when handling moulded products made of solely a powder of a torrefied biomass. Additional advantages are that the moulded product itself is more dense. This is especially advantageous when the moulded product has to be transported over large distances to the pyrolysis or mild gasification process. Not only less feedstock is lost due to for example attrition or breakage also less volume has to be transported for the same feedstock weight.

The invention is also directed to a moulded product comprising of between 1 and 20 wt % of a plastic product and between 99 and 80 wt % of a torrefied biomass.

The invention is also directed to a process to prepare a moulded product as described above by densification wherein a mixture of a plastic product and the powder of a torrefied biomass is fed to a pellet mill and pressed through extrusion channels of the pellet mill wherein the temperature of the mixture in the extrusion channels is such that at least 20 wt % of the powder of a plastic product melts.

The invention is also directed to a process to prepare a char product and a gaseous fraction comprising carbon monoxide and hydrogen from a waste plastic product and torrefied biomass comprising the following steps:
(a) cryogenic milling of the waste plastic product to a powder of a plastic product,
(b) mixing the powder of a plastic product obtained in step (a) with a powder of torrefied biomass,
(c) pressing moulded products using the mixture obtained in step (b) into a moulded product comprising of between 1 and 20 wt % of the plastic product and between 99 and 80 wt % of the torrefied biomass, and
(d) subjecting the moulded products obtained in step (c) to a pyrolysis or mild gasification thereby obtaining the char product and a gaseous fraction comprising carbon monoxide and hydrogen and a mixture of gaseous organic compounds.

The plastic product and the torrefied biomass may be mixed in many different manners. For example the plastic product may be a melt of the plastic product of which examples are described below and which melt may be mixed with a powder of the torrefied biomass in an extrusion moulding process. In a preferred embodiment the plastic product is present as a powder of a plastic product and may be obtained by milling, crushing, tearing and cutting. For example the powder of a plastic product may be obtained by cutting of plastic foils or used carpets. For some plastics and mixtures of plastics it is preferred to obtain the powder by milling and more preferably the powder of the plastic product is obtained by cryogenic milling of a larger plastic product or products.

Cryogenic milling is known and for example described in U.S. Pat. Nos. 4,406,411, 4,483,488, 3,885,744 and 5,203,511. The milling itself may be performed in a grinding mill in the presence of a coolant. The coolant is preferably a liquid gas, more preferably an inert liquid gas. The liquid gas may be a liquid permanent gas such as helium, hydrogen, neon, nitrogen, oxygen, and normal air. Preferably liquid air and more preferably liquid nitrogen is used as a coolant. The temperature at which the milling takes place is suitably at the boiling temperature of the liquid gas and slightly above said temperature. The temperature in step (a) is suitably below minus 150° C. (−150° C.) and preferably below minus 180 (−180° C.).

The milling suitably results in a powder wherein at least 90 wt % of the powder of plastic product will pass through a 12 mesh screen, preferably that more than 90 wt % of the particles pass a 16 mesh sieve, more preferably wherein at least 90 wt % of the powder of plastic product will pass through a 30 mesh screen and even more preferable that more than 90 wt % of the particles pass a 100 mesh sieve. The average particle size is preferably between 30 and 800 micron, more preferably between 50 and 500 micron and even more preferably smaller than 100 micron. The particle size of the plastic product enables one to intimately mix the plastic product with a powder of torrefied biomass without having to liquify the plastic product. Such as mixture can be advantageously be used in well-known pellet mills to make the moulded product. Preferably the size of the plastic product will be in the same range as the size of the powder of torrefied biomass. This is advantageous for the process of making the moulded product in such pellet mills.

The cryogenic milling may be performed using liquid nitrogen using the cooling and grinding technology called PolarFit® Cryogenic Reduction Solutions as offered by Air Products. In such a process the liquid nitrogen may be added directly to the mill chamber of the grinding mill. The liquid gas may also be provided to a conveyor, like a screw conveyor, where the waste polymer product is cooled to its desired low temperature before it enters the mill chamber as for example described in U.S. Pat. No. 3,771,729. For larger shaped waste polymer products it may be desirable to contact the waste products in a so-called tunnel freezer as for example described in U.S. Pat. No. 4,175,396.

Liquid nitrogen is the preferred liquid gas to cool the waste polymer product because it may be easily made in large quantities and because it is inert. Liquid nitrogen is preferably prepared in an air separation process which also prepares an oxygen containing gas which may be advantageously used in the mild gasification process according to the invention. This optimises the use of the air separation process and the products such as the liquid nitrogen and the oxygen containing gas obtained in such a process. The liquid nitrogen will evaporate thereby effectively cooling the plastic product. Alternatively liquid air may be used which is formed in such an air separation unit and which may be separated as a separate product. The oxygen produced in such a process may be obtained in a purity suited for performing the mild gasification process.

The used gaseous nitrogen may be returned to the air separation process to be liquified and reused in the cryogenic milling. The used nitrogen may also be used as reactant in for example an ammonia synthesis process in which it may react with the hydrogen obtained in the present process. Ammonia is an interesting product because it can be easily stored, used as transportation fuel or as a fuel to generate electricity. The advantage of using ammonia as a combustible fuel is that it does not generate greenhouse gasses such as carbon dioxide.

The air separation process is preferably based on the commonly used and most well-known air separation process for oxygen and nitrogen production. This process is based on the Linde double column cycle invented In the first half of the 20th century. The basic concept of the Linde double column cycle is to have thermal communication between the top of the higher pressure column and the bottom of the lower pressure column to condense the vapor nitrogen from the higher pressure column and reboil the liquid oxygen in the bottom of the lower pressure column. Various air separation processes have been designed based on this principle depending on the desired products. Preferably the air separation process produces liquid nitrogen for use in the cryogenic milling and gaseous and/or liquid oxygen for use in the mild gasification and the optional partial oxidation described below. The oxygen may be prepared as liquid oxygen to simplify storage and/or may be obtained as gaseous oxygen for direct use in the mild gasification and the optional partial oxidation

In a preferred embodiment the air separation process is integrated with a liquified natural gas (LNG) regas plant. In this way one or more nitrogen rich gas streams of the air separation plant may be reduced in temperature and/or liquified by indirect heat exchange with the evaporating liquid natural gas of the regas plant as for example described in U.S. Pat. Nos. 5,137,558, 5,139,547, 5,141,543, US2008216512, US2008000266, US2009100863 and EP2669613. Preferably the pressure of the nitrogen rich gas streams is higher than the LNG pressure such that in case of leakage no natural gas will contaminate the nitrogen rich streams. The air separation plant preferably produces both liquid nitrogen and liquid oxygen. This is especially favourable for LNG regas plants which have the function to diversify supply of methane gas to the natural gas grid as an alternative for pipeline gas. Such a regas plant may not continuously prepare the required nitrogen and/or oxygen products while the downstream processes like the cryogenic milling or the partial combustion processes may require a constant flow of these products. By storing a buffer volume of liquid nitrogen and optionally liquid oxygen the desired constant flow may be achieved while the LNG regas plant may temporarily produce at a low production rate.

Alternatively the air separation process is a Pressure Swing Adsorption process wherein zeolite molecular sieves extract oxygen from air. Oxygen at 95% is delivered, while the nitrogen adsorbed by the molecular sieves is vented back into air through the exhaust line or is preferably liquified to prepare liquid nitrogen.

The plastic product is preferably a waste plastic product. The waste plastic product may be comprised of substantially a single polymer as may be the case when recycling used matrasses. Mattresses may be made of a latex (rubber), polyether or polyurethane material. In the recycling of used matrasses it is easy to collect the different used mattresses per polymer material. Cryogenic milling of mattresses have been found an effective method to obtain the polymer powder and to convert the powders into valuable molecules according to the process of the present invention.

The waste plastic product may also be polystyrene and/or expanded polystyrene. These materials are difficult to recycle or depolymerise. In various recycle schemes these products are easily isolated. By milling the material into a powder it is possible to convert these polymers into valuable molecules according to the process of the present invention.

The waste plastic product is preferably a mixture of different waste polymer products. The mixture suitably comprises two polymers of the following list of polymers consisting of LDPE (Low-density polyethylene), HDPE (High-density polyethylene); PP (Polypropylene); PS (Polystyrene); PVC (Polyvinyl chloride); PET (Polyethylene terephthalate); PUT (Polyurethanes) and PP&A fibres (Polyphthalamide fibres), PVC (polyvinylchloride), polyvinylidene chloride, PU (polyurethane), ABS (acrylonitrile-butadiene-styrene), nylon and fluorinated polymers.

Preferably the waste polymer products are substantially only hydrocarbons consisting of only carbon, hydrogen and optionally oxygen. This avoids the formation of nitrogen based combustion gasses and chlorine gasses when PVC is present. Small amounts of these other polymers may be present as contaminants. Preferably the mixture of different waste polymer products at least comprises two polymers of the following list of polymers consisting of LDPE (Low-density polyethylene), HDPE (High-density polyethylene); PP (Polypropylene) and PS (Polystyrene) and PET (Polyethylene terephthalate). Preferably the powder of the waste plastic comprise for more than 50 wt %, more preferably for more than 70 wt %, even more preferably for more than 80 wt % and even more preferably for more than 95 wt % of the listed polymers above. A higher conversion to hydrogen and carbon monoxide may be achieved when these polymers are present.

Other plastics, such as polyvinylchloride, polyvinylidene chloride, polyurethane (PU), acrylonitrile-butadiene-styrene (ABS), nylon and fluorinated polymers are less desirable. The powder of the waste plastic suitably comprises less than 50% by weight, preferably less than 30 wt. %, more preferably less than 20 wt. %, even more preferably less than 10 wt. % of these listed less desirable polymers.

An example of a suitable waste polymer products is the so-called Non-recycled Plastic (NRP).

The powder of the waste plastics may contain other components such as paper, glass, stone, soil and metals. These materials may be present in small amounts and will become part of the carbonaceous or inorganic matrix powder in the moulded product according to the invention. In the pyrolysis or mild gasification they will either partly convert to valuable molecules as in the case of paper or be inert and end up in the char product as will be the case for the glass, stone, soil and metals.

A special powder of a waste plastic is comprised in so-called Automotive Shredder Residue (ASR) or the dust part of the Automotive Shredder Residue. This material may be further milled to the small particles sizes described above by cryogenic milling or may be used as such. This material will contain powder of plastic waste products, such as waste polypropylene, high-impact polypropylene and acrylonitrile butadiene styrene (ABS). The material will further comprise of metals and other inorganic compounds which will serve as the inorganic matrix powder in the moulded product according to the invention. A moulded product comprising Automotive Shredder Residue or the dust part of the Automotive Shredder Residue may further comprise additional carbonaceous or inorganic matrix powder as described above and/or the powder of a waste plastic product as described here above, such as for example the non-recycled plastics.

Preferably the powders obtained in a waste plastic product milling step in a certain time period are mixed such that a powder mixture is obtained having a substantially constant composition. This homogenization may be simply performed in the storage vessels for the powder. For example the powder obtained in a 2 hour period may be homogenised, preferably the powder obtained in a 12 hour period may be homogenised, more preferably the powder obtained in a 24 hour period may be homogenised, even more preferably the powder obtained in a 60 hour period may be homogenised and most preferably the powder obtained in a 120 hour period may be homogenised. The preferred time period may also depend on the variation in time of the composition of the waste plastic products to be milled and the available mixing vessels.

The moulded product may have any shape, such as cylinders, pillow shape like in briquettes, cubes. Preferably the smallest distance from the surface of such a moulded product to its centre is less than 10 mm. This is advantageous for mass transport within the moulded product while performing the pyrolysis or mild gasification process. For example a suitable moulded product is a pellet having the shape of a cylinder suitably having a diameter of between 5 and 12 mm. The length of such cylinders may be between 5 and 80 mm and preferably between 40 and 80 mm. The moulded products may also be made by any other process which results in a compressed article such as a briquetting process or by means of an extrusion process similar to the extrusion process described in for example the afore mentioned US2019/0218371. The pellets are suitably made in a pelletising process, for example using a flat die mill or a ring die mill as pellet mill.

Preferably the moulded product is prepared by densification wherein a mixture of a plastic product, preferably a powder of a plastic product, and the powder of a torrefied biomass is fed to a pellet mill and pressed through extrusion channels of the pellet mill wherein the temperature of the mixture in the extrusion channels is such that at least 20 wt % of the powder of a plastic product melts. Preferably the temperature of the mixture in the extrusion channels is such that at least 50 wt % of the powder of a plastic product melts. When part or all of the plastic product melt when pelletising a more dense and less attrition sensitive pellet may be prepared. The higher temperature may be achieved by increasing the temperature of the mill itself and/or by local temperature increase resulting from frictional forces of the densification process itself. The melted plastic is found to act as a lubricant on the walls of the extrusion channels. This not only lowers the required energy of the pellet mill it also results in that the pellets are more easily discharged from these channels. This avoids the formation of cracks and thus results in a more dense product. This effect is already seen at low contents of plastic, such as between 2 and 5 wt %.

The moulded products suitably have a structural integrity to ensure that they do not disintegrate when performing the pyrolysis or mild gasification. This to enable the fixed powder of the plastic products to convert to the desired gaseous products and coke. The time at which the pyrolysis or mild gasification is performed is relatively long and the moulded products should at least initially have enough strength to not immediately disintegrate and more preferably remain substantially in its moulded product shape.

The powder of the plastic product will due to its plasticity under the conditions wherein a moulded product is pressed or densified result in a relatively strong moulded product. The moulded products will be less sensitive for attrition which will reduce the dust formation during handling of the moulded product. The moulded product may further comprise additional compounds which may originate in contaminants in the waste plastic product or may be compounds added on purpose, for example compounds which catalytically enhance the pyrolysis or gasification reaction. Preferably content of the powder of the plastic product and the powder of torrefied biomass in the moulded product is between 90 and 100 wt %, more preferably between 95 and up to 100 wt % and even more preferably 100%.

Suitably the moulded products comprise of between 1 and 20 wt % of a plastic product and between 99 and 80 wt % of a powder of torrefied biomass, preferably between 2 and 10 wt % of a plastic product and between 98 and 90 wt % of a powder of a torrefied biomass and more preferably between 2 and 5 wt % of a plastic product and between 98 and 95 wt % of a powder of a torrefied biomass. It has been found that even with plastic product contents of up to 5 wt % the advantages of a more dense and stronger product are achieved.

The powder of a torrefied biomass may be obtained by torrefaction of a biomass feed comprising lignocellulosic material. Such a process not only increases the heating value per mass biomass by torrefaction but may also remove a substantial amount of water, especially so-called bound-water, from the starting material comprising lignocellulosic material, further also referred to as biomass material. The energy density of the biomass material is increased by decomposing all or part of the hemicelluloses as present in the biomass. An advantage of using a torrefied biomass feed is that the properties of torrefied biomass feeds obtained from different biomass sources may be more uniform than the properties of the original biomass sources. This simplifies the operation of the process according to the invention.

Torrefaction is a well-known process and for example described in WO2012/102617 and is sometimes referred to as roasting. In such a process the biomass is heated to an elevated temperature, suitably between 260 and 310° C. and more preferably between 250 and 290° C., in the absence of oxygen. Torrefaction conditions are so chosen that a majority of the hemicelluloses decompose while keeping the celluloses and lignin mainly intact. These conditions may vary for the type of biomass material used as feed. The temperature and residence time of the torrefaction process is further preferably so chosen that the resulting material has a high content of so-called volatiles, i.e. organic compounds. The solids residence time may range from seconds to up to an hour depending on the chosen reactor technology. The residence time is suitably chosen such that the content of volatiles of the torrefied biomass is between 50 and 80 wt %, more preferably between 60 and 80 wt % and even more preferably between 65 and 75 wt %. The volatile content is measured using DIN 51720-2001-03. Applicants found that the relatively high volatile content in the torrefied biomass is advantageous to achieve a more carbon efficient pyrolysis or mild gasification process according to the invention.

In the torrefaction process the atomic hydrogen over carbon (H/C) ratio and the atomic oxygen over carbon (O/C) ratio of the biomass material is reduced. Preferably the solid torrefied biomass in the moulded product has an atomic hydrogen over carbon (H/C) ratio of between 0.4 and 0.6 and an atomic oxygen over carbon (O/C) ratio of between 0.4 and 0.6. Further the water content will reduce in a torrefaction process. The moulded products comprising of a solid torrefied biomass suitably contains less than 7 wt %, and more preferably less than 4 wt % water, based on the total weight of the solid torrefied biomass.

The biomass material to be torrefied may be any material comprising hemicellulose including virgin biomass and waste biomass. Virgin biomass includes all naturally occurring terrestrial plants such as trees, i.e. wood, bushes and grass. Waste biomass is produced as a low value by-product of various industrial sectors such as the agricultural and forestry sector. Examples of agriculture waste biomass are corn stover, sugarcane bagasse, beet pulp, rice straw, rice hulls, barley straw, corn cobs, wheat straw, canola straw, rice straw, oat straw, oat hulls and corn fibre. A specific example is palm oil waste such as oil palm fronds (OPF), roots and trunks and the by-products obtained at the palm oil mill, such as for example empty fruit bunches (EFB), fruit fibers, kernel shells, palm oil mill effluent and palm kernel cake. Examples of forestry waste biomass are saw mill and paper mill discards. For urban areas, the best potential plant biomass feedstock includes yard waste (e.g., grass clippings, leaves, tree clippings, and brush) and vegetable processing waste. Waste biomass may also be Specified Recovered Fuel (SRF) comprising lignocellulose.

The biomass material to be torrefied may be a mixture originating from different lignocellulosic feedstocks. Furthermore, the biomass feed may comprise fresh lignocellulosic compounds, partially dried lignocellulosic compounds, fully dried lignocellulosic compounds or a combination thereof.

The torrefied biomass may be easily reduced in size due to its brittle properties after torrefaction to obtain a powder suited to be used as part of the moulded product.

Applicants found that when moulded products are used in a pyrolysis process or mild gasification process as for example described below a char product will be obtained as particles having substantially the same shape as the starting moulded product.

The pyrolysis or mild gasification is preferably performed at so-called non-slagging conditions as for example described in WO2019/054868. This avoids the formation of slag and thus no special measures have to be taken for discharge of the slag and/or protection of the process equipment against the slag or molten slag. The latter enables one to use simpler process equipment.

These non-slagging conditions are achieved by performing the process at a temperature of between 500 and 800° C. and at a solid residence time of between 10 and 60 minutes. The residence time will be chosen within the claimed range such that the reduction in atomic hydrogen over carbon (H/C) ratio of the solids in the pyrolysis or mild gasification process is greater than 50%, preferably greater than 70% and the reduction in atomic oxygen over carbon (O/C) ratio of the solids is greater than 80%. The char product as obtained preferably have an atomic hydrogen over carbon (H/C) ratio of between 0.02 and 0.1 and an atomic oxygen over carbon (O/C) ratio of between 0.01 and 0.06.

In the pyrolysis or mild gasification process a gaseous fraction comprising hydrogen, carbon monoxide and a mixture of gaseous organic compounds and a solid fraction comprising of char particles is obtained. The gaseous organic compounds may comprise of non-condensed organic compounds. These compounds range from methane to organic compounds having up to 50 carbons and even more. The organic compounds include hydrocarbons and oxygenated hydrocarbons. The fraction of these organic compounds in the gaseous fraction may be greater than 15 wt %. The gaseous fraction may also contain sulphur compounds, such as hydrogen sulphide, sulphinated hydrocarbons and chlorine containing compounds like hydrogen chloride and nitrogen containing compounds like ammonia and hydrogen cyanide. The amount of the latter compounds will depend on the composition of the feed material.

The pyrolysis process is performed at a temperature of between 500 and 800° C. and at a solid residence time of between 10 and 60 minutes. The pyrolysis process is performed in the absence of added oxygen. In that situation one refers to the process as a pyrolysis process. The required heat for performing the pyrolysis reaction is preferably generated by indirect heat exchange, for example via a mantle of the reactor in which the pyrolysis takes place.

Preferably the process is performed as a mild gasification process by contacting the moulded products with an oxygen comprising gas at the reaction conditions. For example, the required temperature may then be achieved by a combination of indirect heat exchange, for example by means of flue gasses running through heating pipes or a heating mantle, and a partial oxidation of part of the gaseous fraction as generated in the process. The indirect heating may also be the indirect heating of the reactants of the process before they contact. If such partial oxidation reactions take place one does not refer to such a process as a pyrolysis process. Mild gasification will then be the better description. In such a mild gasification as performed at a temperature of between 500 and 800° C. and at a solid residence time of between 10 and 60 minutes the moulded products are contacted with an oxygen comprising gas. The mild gasification is advantageous compared to pyrolysis because less measures have to be taken to generate the required reaction temperature. Other advantages are increased devolatilization and improved char quality, in terms of less volatiles, due to a better heat distribution over the reactor and therefore an improved heat transfer. The char product as obtained preferably has a content of volatiles of less than 6 wt. %.

The mild gasification process may be performed by contacting the moulded products with an oxygen comprising gas and wherein the amount of oxygen is preferably between 0.1 and 0.3 mass oxygen per mass of moulded product.

The mild gasification is preferably achieved by adding an oxygen comprising gas. The oxygen comprising gas may be oxygen, air or enriched air. The purity of the oxygen comprising gas is preferably at least 90 vol %, more preferably at least 94 vol %, wherein nitrogen, carbon dioxide and argon may be present as impurities. Substantially such pure oxygen is preferred, such as prepared by an air separation unit (ASU) or by a water splitter, also referred to as electrolysis.

Preferably wherein the mild gasification is performed in the presence of oxygen and steam. It has been found that when steam is also present the active surface area of the char particles is substantially higher. It has been found that when the mild gasification process is performed in the presence of oxygen and steam at a temperature of between 500 and 800° C. and at a solid residence time of between 1 and 60 minutes, preferably between 10 and 60 minutes a char product may be obtained having a BET (N₂) active surface areas of between 300 and 500 m²/g or even higher.

The amount of oxygen in such a process also involving steam is suitably between 0.1 and 0.4 kg per kg of the moulded product. The content of oxygen in the combined oxygen steam fraction is suitably between 20 and 40 vol. % O₂ per combined O₂ and H₂O at 300° C.

The process is preferably performed in a continuous process wherein the moulded product is continuously fed to a reactor and contacted with the oxygen comprising gas. The temperature is maintained at the required level by indirect heat exchange in case a pyrolysis is performed or by partial oxidation in case of a mild gasification. In case of pyrolysis heating surfaces may be present in the reactor. The oxygen comprising gas as supplied to the reactor is preferably heated before contacting the moulded products in both the pyrolysis and the mild gasification embodiment. The temperature of the oxygen comprising gas as supplied to the reactor may be between 300 and 500° C. and wherein the temperature is so chosen that water is present as steam at the chosen pressure.

The reactor in both the pyrolysis as the mild gasification process is preferably performed in an elongated furnace wherein the moulded product is continuously transported from a solids inlet at one end of an elongated furnace to a solids outlet at the other end of the elongated furnace. During this transport the moulded product converts to the char particles having similar dimensions. The elongated furnace is preferably a tubular furnace. The means to move the moulded product along the length of the reactor may be by means of a rotating wall and/or by rotating means within the furnace. In case of a rotating wall a rotary kiln furnace may be used as for example described in DE19720417 and U.S. Pat. No. 5,769,007. Preferably a tubular elongated reactor is used having rotating means within the furnace. Such rotating means may be an axle positioned axially in the tubular reactor provided with radially extending arms which move the biomass axially when the axle rotates. More preferably such a reactor is further provided with two or more means to supply the oxygen comprising gas, optionally in admixture with steam, along the length of the elongated reactor and between the solids inlet and solids outlet. These inlets for gas are axially spaced apart.

In the process according to the invention it is therefore preferred to supply the oxygen comprising gas to the elongated reactor at two or more axially spaced apart positions along the length of the reactor between the solids inlet and the solids outlet.

The char product as produced in this process are suitably separated from the gaseous fraction. This separation may be performed as a separate step and using any known solids-gas separation technique at high temperature, suitably between 600 and 1000° C., to avoid condensation of the heavy hydrocarbons. Also to sustain high energy efficiencies of a combined process also involving a downstream partial oxidation of the gaseous fraction as described below. Because the char particles are relatively large no special measures are required to separate the char particles from the gaseous fraction. The char particles are suitably separated from the gaseous fraction by means of simple gravitational forces. For example, the char particles may be obtained via a discharge at the lower end of a separator while the gaseous fraction is discharged at a higher elevation. Any entrained solids in this gaseous fraction may be separated by means of a cyclone. More preferably use is of filters, like candle filters.

The gaseous fraction as separated from the char product may be used as fuel in a combustion process, for example to prepare steam in a boiler or to generate electricity in a gas turbine. The combustion process may also be a power generating process comprising of contacting the fuel with oxygen containing gas having an oxygen content of above 90 vol. %. In such an oxy-process a concentrated carbon dioxide flue gas is obtained which may be stored or used as a chemical feedstock.

Preferably the gaseous fraction is subjected to a partial oxidation at a temperature of between 1000 and 1600° C. and preferably between 1100 and 1600° C., more preferably between 1200 and 1500° C., and at a residence time of less than 5 seconds, more preferably at a residence time of less than 3 seconds. The residence time is the average gas residence time in the partial oxidation reactor. The partial oxidation is performed by reaction of oxygen with the organic compounds as present in the gaseous fraction, wherein a sub-stoichiometric amount of oxygen relative to the combustible matter as present in the gaseous fraction is used. The gaseous organic compounds are converted to hydrogen and carbon monoxide.

A suitable partial oxidation process is for example the Shell Gasification Process as described in the Oil and Gas Journal, Sep. 6, 1971, pp. 85-90. In such a process the gaseous fraction and an oxygen comprising gas is provided to a burner placed at the top of a vertically oriented reactor vessel. Publications describing examples of partial oxidation processes are EP291111, WO9722547, WO9639354 and WO9603345.

The absolute pressure at which the pyrolysis or mild gasification and in optional subsequent partial oxidation process step is performed may vary between 90 kPa and 10 MPa and preferably between 90 kPa and 5 MPa. Pressures at the higher end of these ranges are advantageous when the gaseous fraction is to be used in downstream processes which require a gaseous fraction having such elevated or even higher pressures. The lower pressure range may be used when the gaseous fraction and/or the syngas as prepared from the gaseous fraction is used as fuel for a gas engine or steam boiler to generate electricity. Lower pressures are advantageous when a char particle is desired having a higher active surface.

When the pyrolysis is performed at an elevated pressure the solids and an optional carrier gas will have to be brought to that pressure level before being able to feed this mixture to a pyrolysis reactor. This pressurisation of the solid biomass may be performed in a lock hopper as described in U.S. Pat. No. 4,955,989 and US2011100274. Pressurisation may also be performed using a solids pump as for example described in U.S. Pat. No. 4,988,239 or US2009178336.

If the syngas as prepared in the partial oxidation contains chlorine compounds, for example originating from PVC as part of the powder of plastic products, it may be preferred to reduce the temperature of the syngas by a direct water quench. In such a water quench chlorine will be washed out of the syngas or at least a significant part of the chlorine will be washed out of the syngas. Partial oxidation reactors provided with such a direct water quench are for example described in US2008172941, US2010325957, US2012189499 and US2010143216. Guard beds for treating such acidic gasses may be used. Further solid particles of calcium oxide may be added to the pyrolysis reactor to capture any chlorine gasses.

The syngas mixture as prepared by the above process may be directly used as fuel for example to generate electricity. The syngas mixture may be subjected to a water gas shift reaction to convert part of all of the carbon monoxide to carbon dioxide and water to hydrogen. Such a water gas shift reaction could be beneficial to increase the hydrogen to carbon monoxide ratio as required in downstream processes or to produce hydrogen. The hydrogen can for example be used as fuel for fuel cells, fuels for hydrogen powered combustion engines and gas turbines or it can be mixed into the natural gas grid. Preferably the obtained syngas mixture is used as feedstock in various processes to make chemicals and fuels, such as the Fischer-Tropsch process, methanation process, methanol process, acetic acid process, ammonia process and the DME process.

The char product may be further activated to obtain activated carbon. Activation may be performed by means of a carbonization process, oxidation process or by a chemical activation or by combinations of these processes. The process may be a carbonization process wherein the char particles are heated to a temperature of between 800 and 1000° C. in an inert atmosphere.

The invention is also directed to the following more integrated process. Process to prepare a char product and a gaseous fraction comprising carbon monoxide and hydrogen from a waste plastic product and a torrefied biomass comprising the following steps:
(a) cryogenic milling of the waste plastic product to a powder of a plastic product,
(b) mixing the powder of a plastic product obtained in step (a) with a powder of torrefied biomass,
(c) pressing moulded products using the mixture obtained in step (b) into a moulded product comprising of between 1 and 20 wt % of the plastic product and between 99 and 80 wt % of the torrefied biomass,
(d) subjecting the moulded products obtained in step (c) to a pyrolysis or mild gasification thereby obtaining the char product and a gaseous fraction comprising carbon monoxide and hydrogen and a mixture of gaseous organic compounds.

Preferably liquid nitrogen is used in step (a) as described above. Step (c) is preferably performed as described above in a pellet mill. Step (d) is preferably performed according to this invention. When in step (d) a mild gasification is performed it is preferred to use an oxygen containing gas obtained in the same air separation process from which also the liquid nitrogen is obtained as also described above. The pyrolysis or mild gasification is suitably performed as the process according to this invention. The moulded products as prepared in step (c) are suitably moulded product according to this invention. The gaseous fraction comprising hydrogen, carbon monoxide and a mixture of gaseous organic compounds obtained in step (d) is suitably subjected to a continuously operated partial oxidation to convert the mixture of gaseous organic compounds to hydrogen and carbon monoxide as also described above.

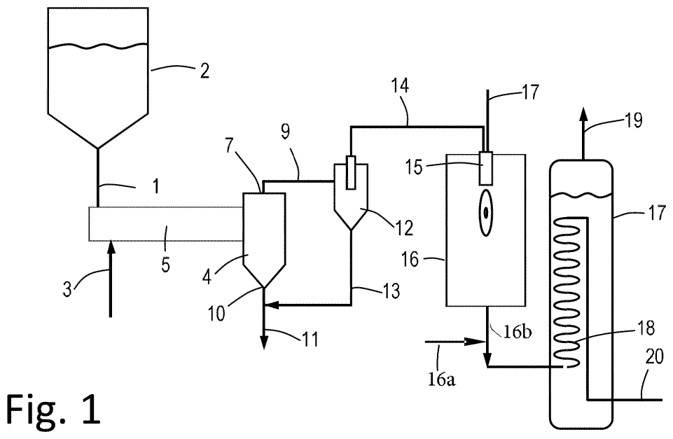

The invention will be illustrated making use of the following FIG. 1.

In FIG. 1 shows a process line up suited for the process according to the invention. Via stream 1 a flow of moulded products according to this invention are discharged as a feed from a biomass feed tank 2. The solid feed is fed to a rotary kiln furnace 5. To this furnace oxygen is fed via stream 3. In rotary kiln furnace 5 the required heat is provided by indirect heat exchange using steam 19 and by the exothermal reaction of the carbonaceous feed and oxygen in furnace 5. At the end of the rotary kiln furnace 5 the char particles as the char product are separated from the gaseous fraction by gravitation wherein the solids drop to a solid outlet 10 in a vessel 4 and the gaseous fraction leaves this vessel via gas outlet tube 7.

The separation vessel 4 is provided with a gas outlet tube 7. Through the gas outlet tube 7 the gaseous fraction comprising hydrogen, carbon monoxide and a mixture of gaseous hydrocarbons is discharged from the vessel via stream 9. The vessel 4 is provided with a solids outlet 10 at the bottom of the vessel 4 through which the char particles are discharged via stream 11. When the furnace 5 is operated at elevated pressures a sluice system may be present at this point to discharge the char particles from the high pressure furnace level to ambient pressure conditions.

The gaseous fraction in stream 9 may still comprise some solid particles. These particles may be separated from the gaseous fraction in a second cyclone separator 12. The solids as separated in stream 13 may be combined with the solids obtained in vessel 4 of stream 11 as shown. The obtained cleaned gaseous fraction in stream 14 is provided to a burner 15 of a partial oxidation reactor 16. To said burner also an oxygen comprising gas is fed via stream 17 and optionally a moderator gas, like steam (not shown). The hot syngas mixture as obtained in reactor 16 is contacted by injecting methane as supplied in stream 16a into stream 16b to perform the chemical quench. The thus cooled syngas is further reduced in temperature by introducing the syngas to the tube 18 side of a sensible heat boiler 17. In the sensible heat boiler 17 water evaporates to obtain steam which is discharged from the boiler via stream 19. The syngas mixture is cooled and discharged via stream 20.

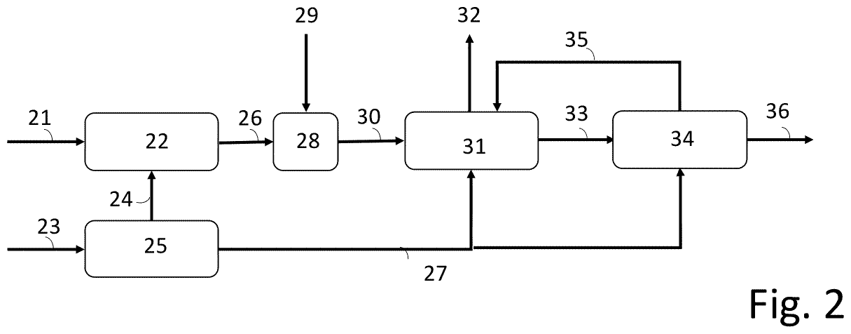

FIG. 2 shows an integrated process wherein a char product 32 and a gaseous fraction 33 comprising carbon monoxide and hydrogen from a waste plastic product 21 is prepared. In this process the waste plastic product 21 is cryogenic milled to a powder 26 of a plastic product in a cryogenic milling step (a) 22. In this cryogenic milling step 22 liquid nitrogen 24 is prepared in an air separation unit 25 using air 23 as feed. In a step (b) the powder 26 of a plastic product is mixed with a powder 29 of a torrefied biomass and pressed into moulded products 30 in a step (c). The moulded products are subjected to a mild gasification in step (d). To the mild gasification step 31 oxygen 27 as prepared in air separation unit 25 is added. Steam 35 may be used to provide the required in the mild gasification step 31 by indirect heat exchange. In this step char particles 32 are obtained and a gaseous fraction 33 comprising carbon monoxide and hydrogen and a mixture of gaseous organic compounds. The gaseous fraction 33 is subjected in a step (e) to a continuously operated partial oxidation process 34 to convert the mixture of gaseous organic 1s compounds to a syngas 36 comprising of hydrogen and carbon monoxide. Steam 35 is obtained in a syngas cooling step as part of the partial oxidation 34. In partial oxidation process 34 oxygen 27 as prepared in air separation unit 25 is used.

The invention will be illustrated by the following non-limiting example.

### EXAMPLE

Pellets were made consisting of the following materials. Torrefied biomass powder as obtained by torrefaction of wood biomass for 60 minutes at 290° C. The torrefied biomass was sieved to a particle size of <500 μm. Medium density polyetyhlene (MDPE) powder having a density of 940 kg/m3, a melting point of between 109-111° C. (obtained from Sigma-Aldrich (CAS nr 9002-88-44)). The MDPE powder was sieved to a size of <220 μm. Potato starch of the Honig brand was used to prepare comparable pellets using the state of the art starch binder.

Pellets having a diameter of 10 mm were made in a single press provided with a temperature controlled die. The pellets were made by applying a plunger pressure of 2000 kg during 150 seconds at different die temperatures. The resulting pellets are listed in Table 1.

TABLE 1

| | Temperature of the | Content MDPE binder |
|---|---|---|
| Pellet | press (° C.) | (wt %) |
| A1 | 80 | 0 |
| 1 | 80 | 2 |
| 2 | 80 | 5 |
| A2 | 105 | 0 |
| 3 | 105 | 2 |
| 4 | 105 | 5 |
| A3 | 105 | 3 wt % starch |
| A4 | 135 | 0 |
| 6 | 135 | 2 |
| 7 | 135 | 5 |
| A5 | 135 | 3 wt % starch |

The pellets containing starch as the binder represented pellets according to the state of the art.

The density was measured of pellets and it was found that by adding a MDPE plastic product the density of the pellets increased. Further higher die temperatures resulted in higher pressures.

The impact resistance was measured of the pellets. Pellets and their fragments were dropped from a height of 1.96 m in a steel pan with a 8 mm thick bottom. This was repeated four times. If after four drops no breakage occurred the pellets were dropped until breakage. The impact resistance (IRI) was calculated by dividing the average number of drops by the average number of pieces times 100:

IRI=((Average number of drops)/(Average number of pieces))×100

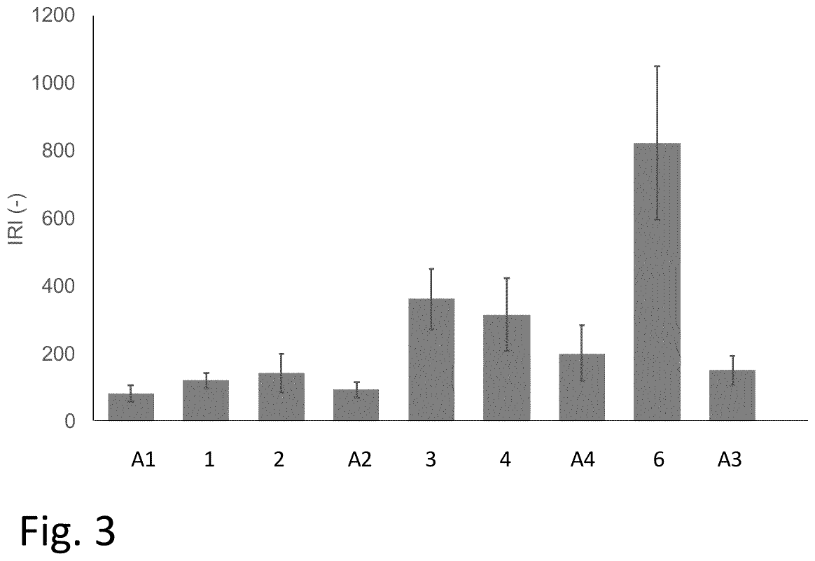

The higher the number for IRI the stronger the pellet in this drop test. The results are shown in FIG. 3 for pellets A, 1, 2, A2, 3, 4, A4, 6 and A3. The IRI for pellet 7 of Table 1 could not be calculated because it did not break, even after 60 drops. The results show that the addition of MDPE plastic product at a pelletising temperature above the melting temperature of the plastic product resulted in the strongest product as compared to pellets made at a lower temperature of pellets made with the state of the art starch binder.

1. A process for a combined biomass and plastic product conversion by subjecting a moulded product comprising of between 1 and 20 wt % of a plastic product and between 99 and 80 wt % of a torrefied biomass to a pyrolysis or mild gasification thereby obtaining a gaseous fraction comprising hydrogen, carbon monoxide and a mixture of gaseous organic compounds and a char product.

2. The process according to claim 1, wherein the gaseous fraction is separated from the char product and wherein the gaseous fraction is subjected to a partial oxidation at a temperature of between 1000 and 1600 C wherein the gaseous organic compounds as present in the gaseous fraction are converted to hydrogen and carbon monoxide.

3. The process according to claim 1, wherein the moulded product comprising of a powder of a plastic product and a powder of a torrefied biomass.

4. The process according to claim 1, wherein the moulded products comprise of between 1 and 20 wt % of a plastic product and between 99 and 80 wt % of a torrefied biomass and preferably wherein the moulded products comprise of between 2 and 5 wt % of a plastic product.

5. (canceled)

6. The process according to claim 1, wherein the pyrolysis or mild gasification is performed at a temperature of between 500 and 800° C. and at a solid residence time of between 10 and 60 minutes.

7. The process according to claim 1, wherein the pyrolysis or mild gasification is performed in an elongated furnace wherein the moulded products are continuously transported from a solids inlet at one end of an elongated furnace to a solids outlet at the other end of the elongated furnace and
wherein an oxygen comprising gas is supplied to the elongated reactor at two or more axially spaced away positions along the length of the reactor between the solids inlet and the solids outlet.

8. The process according to claim 1, wherein the moulded products are subjected to a mild gasification wherein the mild gasification is performed in the presence of oxygen and steam and by contacting the moulded products with an oxygen comprising gas and wherein the amount of oxygen is between 0.1 and 0.3 mass oxygen per mass of moulded product.

9. (canceled)

10. (canceled)

11. The process according to claim 1, wherein the plastic product is a waste plastic product.

12. The process according to claim 11, wherein the waste plastic product is a powder of the waste plastic product is obtained by milling a mixture of different waste polymer products.

13. The process according to claim 12, wherein the mixture of different waste polymer products comprises at least two polymers of the following list of polymers consisting of LDPE (Low-density polyethylene), HDPE (High-density polyethylene); PP (Polypropylene); PS (Polystyrene); PET (Polyethylene terephthalate) and wherein the powder of the waste plastic product comprises for more than 50 wt % of these list of polymers.

14. The process according to claim 11, wherein the powder of a plastic product is obtained by cryogenic milling of a larger plastic product or products.

15. (canceled)

16. The process according to claim 14, wherein at least 90 wt % of the powder of plastic product will pass through a 30 mesh screen.

17. A moulded product comprising of between 1 and 20 wt % of a plastic product and between 99 and 80 wt % of a torrefied biomass.

18. The moulded product according to claim 17, comprising between 2 and 5 wt % of a plastic product.

19. The moulded product according to claim 17, wherein the plastic product is a powder of a plastic product.

20. The moulded product according to claim 19, wherein the powder of a plastic product is obtained by cryogenic milling of a larger plastic product, wherein at least 90 wt % of the powder of plastic product will pass through a 12 mesh screen and wherein the plastic product is a mixture of different waste polymer products.

21. The moulded product according to claim 20, wherein the mixture of different waste polymer products comprises at least two polymers of the following list of polymers consisting of LDPE (Low-density polyethylene), HDPE (High-density polyethylene); PP (Polypropylene); PS (Polystyrene); PET (Polyethylene terephthalate) and wherein the powder of the waste plastic product comprises for more than 50 wt % of these list of polymers.

22. The moulded product according to claim 21, wherein the powder of the waste plastic product comprise suitably comprise less than 30 wt. % of the total of polyvinylchloride, polyvinylidene chloride, polyurethane (PU), acrylonitrile-butadiene-styrene (ABS), nylon and fluorinated polymers.

23. A process to prepare a moulded product according to claim 17 by densification wherein a mixture of a plastic product and the powder of a torrefied biomass is fed to a pellet mill and pressed through extrusion channels of the pellet mill wherein the temperature of the mixture in the extrusion channels is such that at least 20 wt % of the powder of the plastic product melts.

24. The process according to claim 23, wherein the temperature of the mixture in the extrusion channels is such that at least 50 wt % of the powder of a plastic product melts.

25.-31. (canceled)
